(19) United States
(12) Patent Application Publication
(10) Pub. No.: US 2024/0092623 A1
(43) Pub. Date: Mar. 21, 2024

(54) Elastic Coupling Assembly and Electric Can Opener Thereof

(71) Applicant: Ningbo Lobone Household Items Co., Ltd., Ninghai County (CN)

(72) Inventor: Quansheng Wang, Ninghai County (CN)

(21) Appl. No.: 18/259,895

(22) PCT Filed: Aug. 2, 2022
(86) PCT No.: PCT/CN2022/109576

§ 371 Date: Jun. 29, 2023

(30) Foreign Application Priority Data
Aug. 3, 2021 (CN) 202121799436.3

(51) Int. Cl. B67B 7/00; F16D 3/64

(52) U.S. Cl. CPC B67B 7/385; F16D 3/64

(57) ABSTRACT

An elastic coupling assembly comprises a first brake gear, a second brake gear, a coupling, a plurality of elastic bodies, a plurality of first protrusions, at least two second protrusions; wherein, the plurality of first protrusions is arranged on a surface of the first brake gear which faces the second brake gear; the at least two second protrusions are arranged at intervals on the surface of the coupling which faces the first brake gear; each second protrusion has a notch, each first protrusion is clamped between two adjacent second protrusions; when the first brake gear rotates in one direction, each first protrusion comes into contact with the corresponding elastic body, when the first brake gear rotates in the other direction, each first protrusion comes into contact with the second protrusion opposite to the corresponding elastic body. The present invention further comprises an elastic can opener having the elastic coupling assembly.

### TECHNICAL FIELD OF THE INVENTION

The invention relates to the technical field of small household tools, in particular to an elastic coupling assembly and an electric can opener thereof.

### BACKGROUND OF THE INVENTION

In recent years, in many countries and areas, for the convenience of life, some cooked products are processed and packaged into cans, so it is convenient to carry on a trip, and it is quick to eat. Can openers are a kind of household tools invented for opening cans. In the manual can openers in the market at present, a blade and a roller are equipped in the lower portion of the front end of the handle, and a rotary handle is connected to the roller. The can wall is clamped between the blade and the roller, and the blade is tightened so that the blade cuts into the can call. Then, the rotary handle is rotated to drive the roller to move around the can wall by one circle, so that the can wall is cut.

With the progress of science and technology, can openers have also followed the pace of the science and technology and have been gradually evolved from manual can openers to electric can openers. However, a cutting principle of the electric can openers is similar to that of the manual can openers. At present, there are two main types of electric can openers, i.e., conventional table can openers and line cutting can openers. The line cutting can openers are small battery-powered devices, which can be put on the top of the can and rotate relative to the can during operation. The gear transmission and braking mechanism is driven to move mechanically by a motor, so that the cutting blade is driven to stress the surface of the can, thereby achieving the effect of completely cutting the packaged can.

For example, an American patent US20140059869A1 disclosed a can opener. The can opener comprises a housing, a driving gear, a reduction transmission device, a cutting wheel, a slider, an idling wheel, a first driven gear, a second driven gear, a torsion spring, a third driven gear and a cam; wherein the driving gear rotates the cutting wheel and the first driven gear, the first driven gear drives the second driven gear, the third driven gear rotates the cam, the cam moves the slider, and the slider moves the idling wheel, so that the idling wheel is moved to the cutting wheel to clamp the rim of the lid between the idling wheel and the cutting wheel. The idling wheel and the cutting wheel are moved along the rim of the lid to cut the rim of the lid and to separate the lid from the can so as to open the can automatically.

The can opener further comprises a torsion spring. The torsion spring is biased between the first driven gear and the second driven gear to connect them. After the circular motion of the idling wheel and the cutting wheel is finished, the second driven gear is driven by the restoring force of the torsion spring to rotate in the reverse direction, thereby realizing retraction and resetting.

In this approach and escape motions of the can opener driven by a baking mechanism composed of two plastic gears and a torsion spring, the production and assembly processes are tedious and complex, and the quality is unstable. When a user uses the can opener to cut a can, the user cannot cut the can at one time, the blade will be blocked, and the can cannot be separated from the can opener, thereby causing unstable product quality and inconvenience to the user. When in use, the blade will be blocked and cannot be retracted to the specified position, and a standstill will occur in the process of cutting the can, thereby causing inconvenience to the user and unstable product quality. In addition, since the service life of the torsion spring is limited, the frequency of continuous use of the can opener is also limited.

### SUMMARY OF THE INVENTION

It is a first object of the present invention to provide an elastic coupling assembly, which improves the stability of escape motions of the can opener and prolongs the service life.

It is a second object of the present invention to provide an electric can opener having the elastic coupling assembly.

For achieving the first object, the elastic coupling assembly comprises a first brake gear; a second brake gear arranged coaxially with the first brake gear; a coupling for connecting the first brake gear and the second brake gear; a plurality of elastic bodies; a plurality of first protrusions arranged on the first brake gear; at least two second protrusions arranged on the coupling; wherein, the plurality of first protrusions is arranged on a surface of the first brake gear which faces the second brake gear; the at least two second protrusions are arranged at intervals on the surface of the coupling which faces the first brake gear; each second protrusion has a notch for receiving one elastic body, each elastic body is partially located inside the notch and partially extends out from the notch; each first protrusion is clamped between two adjacent second protrusions; when the first brake gear rotates in one direction, each first protrusion comes into contact with the corresponding elastic body, when the first brake gear rotates in the other direction, each first protrusion comes into contact with the second protrusion opposite to the corresponding elastic body.

Preferably, to facilitate the torque transmission between the first brake gear and the coupling, the plurality of first protrusions is distributed radially, and a circular ring is arranged in a center of the plurality of first protrusions; the plurality of second protrusions is distributed radially, and the coupling matches the circular ring of the first brake gear at a center of the plurality of second protrusions.

Preferably, to facilitate the torque transmission between the second brake gear and the coupling, a plurality of third protrusions distributed radially is arranged on the surface of the second brake gear facing the first brake gear, so as to be engaged with the coupling.

For achieving the second object, the electric can opener having the elastic coupling assembly comprises a driving mechanism which comprises a motor having an output, a transmission mechanism and a brake mechanism; wherein, the electric can opener has a first load and a second load; the brake mechanism comprises an input end capable of braking the first load of the electric can opener, and an output end which is driven to move by the second brake gear and is capable of braking the second load of the electric can opener; the output of the motor is transmitted to the input end of the brake mechanism by the transmission mechanism transmits, the first brake gear is connected to and driven to rotate by the input end; the motor is capable of rotating positive direction or negative direction.

Preferably, to facilitate the cooperation with the first brake gear, the second load is cooperated with the second brake gear, the input end is a driving gear which meshes with the first brake gear, the output end comprises a third brake gear and a cam which rotate together, and the third brake gear meshes with the second brake gear.

Preferably, to facilitate the input end and the output end to drive the corresponding loads to do different motions, the driving mechanism further comprises a driving shaft which passes through the driving gear and the third brake gear, and the driving shaft rotates together with the driving gear, and is capable of rotating relative to the third brake gear.

To transmit the output torque of the motor to the brake mechanism, preferably, the transmission mechanism is a gear set, a primary gear of the transmission mechanism is connected to the output shaft of the motor, and a final gear of the transmission mechanism meshes with the driving gear.

Preferably, the electric can opener further comprises a housing and a cutting assembly, the motor and the transmission mechanism of the driving mechanism are disposed inside the housing, the output end of the brake mechanism is disposed outside the housing, and, the input end and the output are respectively connected to the cutting assembly.

Preferably, the electric can opener comprises a housing and a cutting assembly, and the cutting assembly comprises a slider, a driven member, a cutting wheel as the first load, and an idling wheel as the second load, the driven member is disposed between the slider and the third brake gear, the cam is disposed in the driven member and can push the driven member to move, so that the driven member is capable of pushing the slider to move; the cutting wheel and the idling wheel are disposed on one side of the slider away from the driven member, the driving shaft passes through the driven member and the slider to be fixedly connected to the cutting wheel, and, the idling wheel can be fixedly connected to the slider, so as to make the idling wheel close to or away from the cutting wheel with the movement of the slider.

To facilitate the cooperation of the portions of the brake mechanism inside and outside the housing, preferably, the housing comprises a mounting seat having a recess extending upward from a bottom surface of the housing facing the can; the input end, the first brake gear and the second brake gear are located inside the housing, and the third brake gear and the cam are located in the mounting seat, the mounting seat has a gap at the sidewall of the housing, and partial of second brake gear is engaged with the third brake gear after passing through the gap, and, the idling wheel is at least partially located in the mounting seat.

Preferably, the electric can opener further comprises a control circuit for controlling the driving mechanism; the control circuit comprises a controller and a driving circuit for controlling the act of the motor according to the instruction of the controller; the driving circuit comprises a current detection circuit for detecting the operating current of the motor; and, the controller is electrically connected to the current detection circuit and can receive a signal from the current detection circuit.

Compared with the prior art, the present invention has the following advantages. Under the design that the first brake gear is connected to the second brake gear through the elastic coupling, firstly, compared with the metal spring, the elastic coupling is easier to mount and will not be bounced; secondly, compared with the metal spring, no impact will be caused during the reversion of the elastic coupling, it is avoided that the metal spring is easier to break under repeated impact, thereby the elastic coupling having longer service life; and thirdly, compared with one-side contact and guidance, the elastic coupling is stressed more uniformly and more stable in use due to uniform evenly circumferential contact.

### BRIEF DESCRIPTION OF THE DRAWINGS

FIG. 1 is a perspective view of an electric can opener according to an embodiment of the present invention (viewed from top to bottom);

FIG. 2 is a perspective view of the electric can opener according to the embodiment of the present invention (viewed from bottom to top);

FIG. 3 is a perspective view of the electric can opener when a cutting assembly is omitted according to the embodiment of the present invention;

FIG. 4 is a perspective view of the electric can opener when a housing and a cutting assembly are omitted according to the embodiment of the present invention;

FIG. 5 is an exploded view of the electric can opener when a part of the housing is omitted according to the embodiment of the present invention;

FIG. 6 is a sectional view of the electric can opener according to the embodiment of the present invention;

FIG. 7 is a perspective view of the elastic coupling assembly according to the embodiment of the present invention;

FIG. 8 is a perspective view of a first brake gear of the elastic coupling assembly according to the embodiment of the present invention;

FIG. 9 is an exploded view of the elastic coupling assembly according to the embodiment of the present invention;

FIG. 10 is another exploded view of the elastic coupling assembly according to the embodiment of the present invention;

FIG. 11 is a perspective view of a third brake gear and a cam of the can opener according to the embodiment of the present invention.

### DETAILED DESCRIPTION OF THE INVENTION

The present invention will be further described in detail with reference to the accompanying drawings by embodiments, throughout which the same or similar reference numerals indicate the same or similar elements or elements having the same or similar functions.

It should be noted that in the description of the present invention, the terms “center”, “longitudinally”, “horizontally”, “length”, “width”, “thickness”, “up, down”, “front, back”, “left, right”, “vertical”, “parallel”, “top, bottom”, “inside, outside”, “clockwise”, “counterclockwise”, “axial direction”, “radial direction”, “circumferential direction”, etc. to describe a direction or position based on the accompanying drawings are only used for describe the present invention and simplify the description, instead of indicating that devices or elements must have particular orientation or must be constructed and operated in a particular orientation. Since the embodiments disclosed by the present invention can be set in different directions, these terms indicating directions are only used as explanations and should not be used as restrictions. For example, the verbs “up”, “down” should not be limited to the direction opposite or consistent with the gravity. In addition, a feature defined as “first” or “second” may explicitly or implicitly comprises one or more such features.

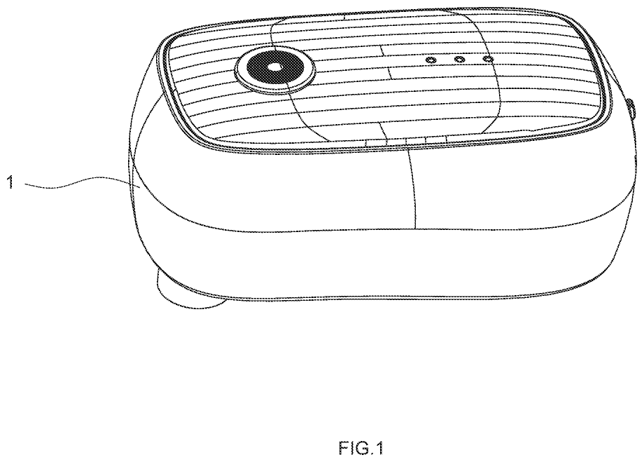

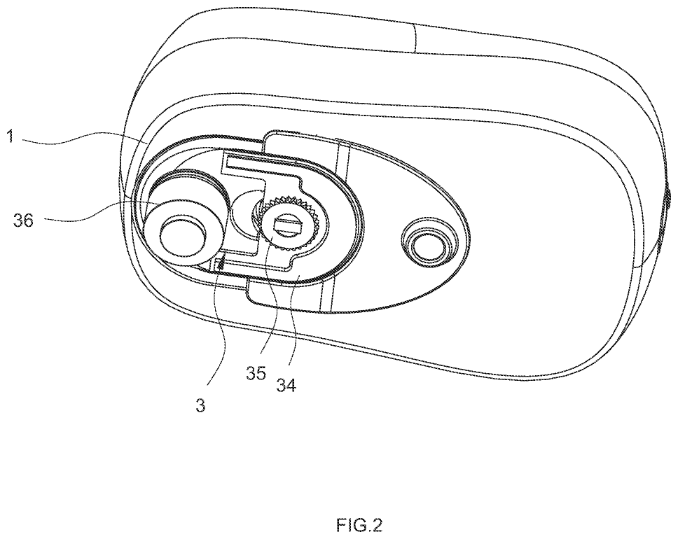

FIGS. 1-2 show a preferred embodiment of the electric can opener of the present invention. The electric can opener comprises a housing 1, a driving mechanism and a cutting assembly 3 driven by the driving mechanism. The housing 1 has a closed chamber for most of the driving mechanism to locate inside.

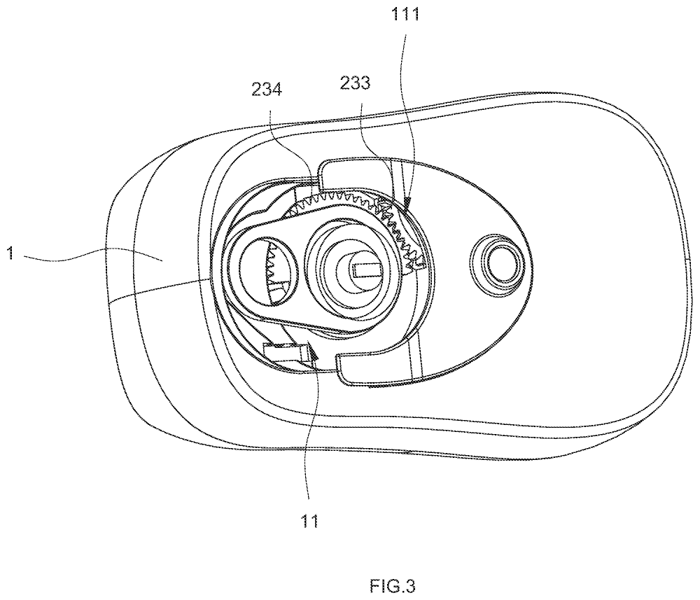

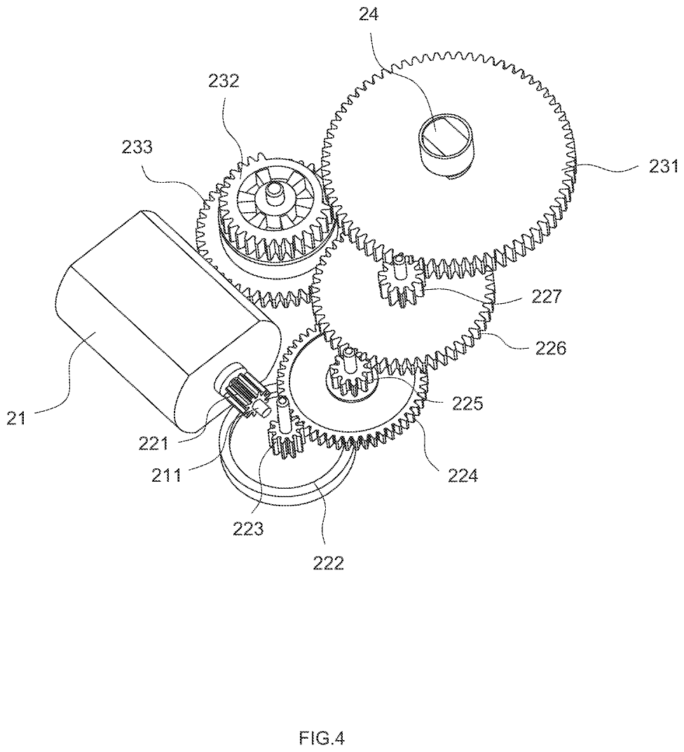

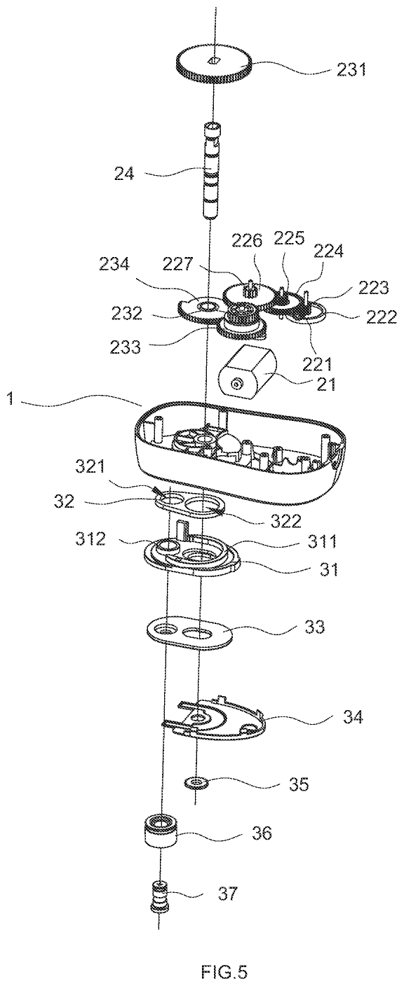

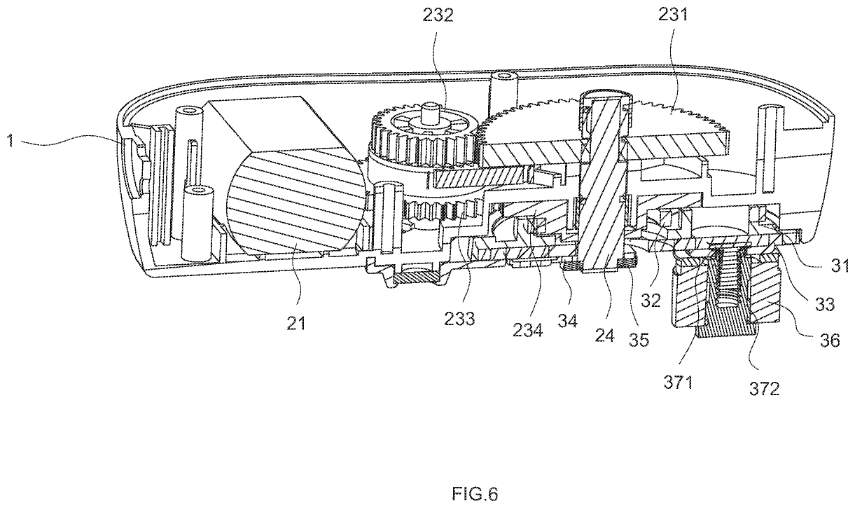

As shown in FIGS. 3-6, the driving mechanism comprises a motor 21, a transmission mechanism and a brake mechanism. The transmission mechanism transmits the output torque of the motor 21 to the brake mechanism, and the output torque is then transmitted to the cutting assembly 3 through the brake mechanism.

In this embodiment, the transmission mechanism is a gear set, wherein the primary gear (input end) is connected to the motor 21, and the final gear (input end) of the transmission mechanism is connected to the brake mechanism. When the transmission mechanism has only one gear, the primary gear and the final gear are the same gear. In this embodiment, the transmission mechanism comprises a first transmission gear 221 disposed on the output shaft 211 of the motor 21, a second transmission gear 222 meshed with the first transmission gear 221, a third transmission gear 223 arranged coaxially with the second transmission gear 222, a fourth transmission gear 224 arranged coaxially with the third transmission gear 223, a fifth transmission gear 225 arranged coaxially with the fourth transmission gear 224, a sixth transmission gear 226 meshed with the fifth transmission gear 225, and a seventh transmission gear 227 arranged coaxially with the sixth transmission gear 226. The first transmission gear 221 is the primary gear of the transmission mechanism, and the seventh transmission gear 227 is the final gear of the transmission mechanism. Two gears arranged coaxially rotate synchronously. In the transmission mechanism, except for the first transmission gear 221, the other transmission gears are rotatably connected to the housing through rotating and support members such as rotating shafts. Thus, the space in the housing 1 can be saved, and it can be avoided that the housing 1 is too large.

When in use, the output shaft 211 of the motor 21 usually extends transversely, and the rotating shaft of the first transmission gear 221 is the output shaft 211 of the motor 21. The first transmission gear 221 and the second transmission gear 222 are helical gears, such as bevel gears, so as to realize the steering of the output, and the output shaft of the second transmission gear 222 is in a longitudinally extending state. The rotating shaft of the third transmission gear 223 is coaxial with the second transmission gear 222, and the rotating shafts of the other transmission gears of the transmission mechanism are parallel to the second transmission gear 222.

In this embodiment, the brake mechanism is also a gear set. The input end of the brake mechanism is connected to the final gear of the transmission gear to realize transmission, while the output end thereof is connected to the cutting assembly 3 to realize transmission. In this embodiment, the brake mechanism comprises a driving gear 231, a first brake gear 232, and a second brake gear 233 arranged coaxially with the first brake gear 232; wherein the driving gear 231, as the input end of the brake mechanism, meshes with the seventh transmission gear 227 of the transmission mechanism.

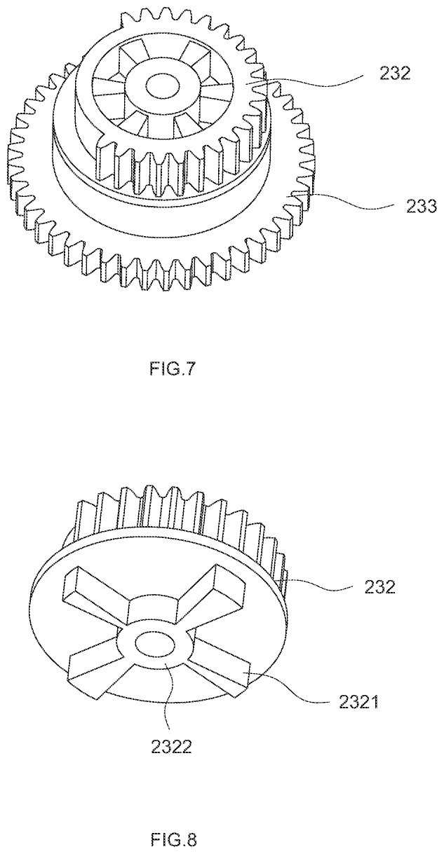

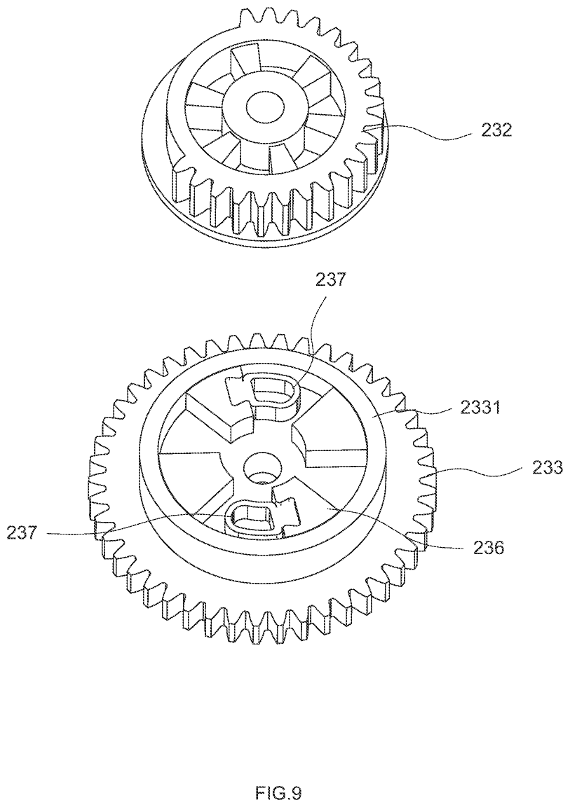

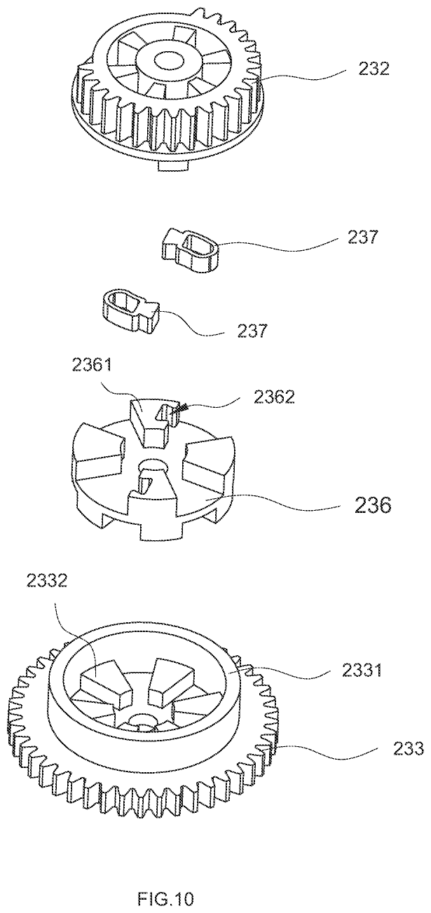

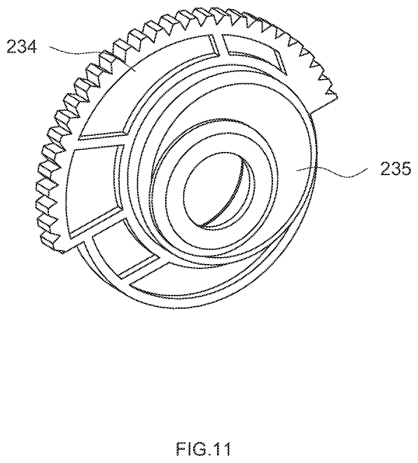

The first brake gear 232 meshes with the driving gear 231. As shown in FIGS. 7-10, the first brake gear 232 and the second brake gear 233 are rotatably connected to the housing 1 through a same rotating shaft. The teeth of the first brake gear 232 may be only distributed in a circular ring, and are not arranged on the whole circumference. The first brake gear 232 has a plurality of first protrusions 2321 arranged on one side of the first brake gear 232 facing the second brake gear 233. In this embodiment, there is multiple (e.g., four) first protrusions 2321, a circular ring 2322 is arranged in the middle of these first protrusions 2321, and the first protrusions 2321 are distributed radially outward from the periphery of the circular ring 2322.

A coupling 236 and a plurality of elastic bodies 237 are arranged between the first brake gear 232 and the second brake gear 233, so that the four parts form an elastic coupling assembly. The second brake gear 233 facing the first brake gear 232 is protruded toward the first brake gear 232 to form a limiting ring 2331. The limiting ring 2331 is cylindrical, and the end of the limiting ring 2331 is resisted against the first brake gear 232. The coupling 236 and the plurality of elastic bodies 237 are arranged in the space encircled by the limiting ring 2331. A plurality of third protrusions 2332 distributed radially is arranged on the surface of the second brake gear 233 facing the first brake gear 232, so as to be engaged with and position the coupling 236.

At least two second protrusions 2361 are arranged at intervals on the surface of the coupling 236 which faces the first brake gear 232. In this embodiment, multiple (e.g., four) second protrusions 2361 are distributed radially, and the middle portion of each second protrusion 2361 is matched with the circular ring 2322 of the first brake gear 232. The first protrusions 2321 and the second protrusions 2361 are arranged to make the first brake gear 232 to be engaged with the coupling 236. Each second protrusion 2361 has a notch 2362 for receiving one elastic body 237; each elastic body 237 is partially located inside the notch 2362 and partially extends out from the notch 2362. Thus, each first protrusion 2321 is clamped between two adjacent second protrusions 2361; when the first brake gear 232 rotates in one direction, each first protrusion 2321 comes into contact with the corresponding elastic body 237, when the first brake gear 232 rotates in the other direction, each first protrusion 2321 comes into contact with the second protrusion 2361 opposite to the corresponding elastic body 237.

The first brake gear 232 and the second brake gear 233 are connected through the elastic coupling composed of the coupling 236 and the elastic bodies 237, forming a gear set with certain flexibility. When the driving gear 231 meshes with the first brake gear 231 and rotates counterclockwise, the elastic coupling comes into contact with the first brake gear 232 (the elastic bodies 237 are elastically resisted against the first protrusions 2321 of the first brake gear 232) to form a reverse torque and drive the second brake gear 233 to rotate counterclockwise; and, when the driving gear 231 stops rotation or rotates in the opposite direction, the first brake gear 232 is subjected to the torque of the elastic coupling to push the first brake gear 232 to mesh with the driving gear 231 or rotate clockwise. After the brake gear 232 is normally meshed with the driving gear 231, the first brake gear 232 comes into rigid contact with the second brake gear 233 through the elastic coupling (the first protrusions 2321 of the first brake gear 232 are resisted against the second protrusions 2361 facing the elastic bodies 237), and the second brake gear 233 rotates clockwise.

The driving mechanism further comprises a driving shaft 24 passing through the driving gear 231, and the joint of the driving shaft 24 with the driving gear 231 is a flat shaft. Thus, when the driving gear 231 rotates, the driving shaft 24 is driven to rotate synchronously. The housing 1 comprises a mounting seat 11, and the driving shaft 24 passes through the mounting seat 11 and rotates about its own shaft relative to the mounting seat 11. For the convenience of gripping and cutting, the housing 1 is oval-shaped. The motor 21 is arranged at one end of the housing 1, while the mounting seat 11 is arranged at the opposite end of the housing 1. The housing 1 comprises a mounting seat 11 having a recess extending upward from a bottom surface of the housing 1 facing the can.

The brake mechanism further comprises a third brake gear 234 arranged on the driving shaft 24, and the third brake gear 234 and the driving shaft 24 can rotate relative to each other. The third brake gear 234 meshes with the second brake gear 233, and thus being driven to rotate by the second brake gear 233. A cam 235 is arranged on the surface of the third brake gear 234 facing the mounting seat 11. As shown in FIG. 11, the third brake gear 234 and the cam 235 are integrated to form the output end of the brake mechanism. Similarly, the driving shaft 24 passes through the cam 235, and the cam 235 and the driving shaft 24 can rotate relative to each other. The cam 235 is circular, and the driving shaft 24 is eccentrically connected to the cam 235. The third brake gear 234 is fan-shaped, and the central angle of the fan is related to the distance between the cutting wheel 35 and the idling wheel 36 (described in details below) of the cutting assembly 3.

The rotating shafts of the four brake gears of the brake mechanism are parallel to the rotating shaft of the final gear (the seventh transmission gear 227) of the transmission mechanism. The driving gear 231 is disposed on one side of the mounting seat 11 facing the inside of the housing 1, and the third brake gear 234 is disposed on one side of the mounting seat 11 facing the outside of the housing. That is, the third brake gear 234 is disposed inside the mounting seat 11. Since the first brake gear 232 and the second brake gear 233 are arranged inside the housing 1, a gap 111 is formed on the sidewall of the mounting seat 11, so that the second brake gear 233 can partially pass out of the housing 1 from the gap 111 to meshes with the third brake gear 234.

The cutting assembly 3 comprises a slider 31, a driven member 32, a gasket 33 and a metal plate 34 all arranged in the mounting seat 11. The driven member 32 is arranged on a surface of the slider 31 facing the third brake gear 234, so as to move in cooperation with the slider 31. To enable the driven member 32 to push the slider 31 to move when the driven member 32 acts, a flange 311 protruded toward the third brake gear 234 is arranged on the slider 31, and the flange 311 surrounds the periphery of the driven member 32 and is capable of being fitted with the driven member 32 so as to push the driven member 32. To limit the position of the driven member 32, a bump 312 extending toward the third brake gear 234 is further disposed on the slider 31, and the bump 312 is ring-shaped. A positioning hole 321 is formed on the driven member 32, and the bump 312 passes through the positioning hole 321, so that the slider 31 and the driven member 32 are rotatably connected. A mounting hole 322 is further formed on the driven member 32, the cam 235 is arranged in the mounting hole 322 which is a circular hole fitted with the cam 235. Thus, when the cam 235 rotates eccentrically, the driven member 32 is driven to rotate (e.g., swing) about the driving shaft 24.

The gasket 33 is arranged on one side of the slider 31 away from the third brake gear 234, and the gasket 33 is fixed to the slider 31 so that they can move synchronously. The metal plate 34 is arranged on one side of the gasket 33 away from the slider 31, so that the housing 1 can be prevented from damage by friction with the can during cutting. The driving shaft 24 passes through the mounting seat 11 and then successively passes through the mounting hole 322 of the driven member 32, the slider 31, the gasket 33 and the metal plate 34, so that the slider 31 and the gasket 33 an rotate about the driving shaft 24. The metal plate 34 is rotatably connected to the driving shaft 24 and does not move with the slider 31 and the gasket 33.

The cutting assembly 3 further comprises a cutting wheel 35 as a first load and an idling wheel 36 as a second load. The cutting wheel 35 is arranged on one side of the metal plate 34 away from the slider 31, and the driving shaft 24 passes through the metal plate 34 and is then connected to the cutting wheel 35, so that the cutting wheel 35 rotates with the driving shaft 24. The idling wheel 36 is arranged on one side of the gasket 33 away from the slider 31, and the idling wheel 36 is fixedly connected to the gasket 33 through a fastener 37. In this embodiment, the fastener 37 comprises a screw 371 and an inverted screw 372. The inverted screw 372 passes through the idling wheel 36 from bottom to top, and the screw 371 passes through the inverted screw 372 from the gasket 33, thereby realizing locking. Thus, the idling wheel 36 synchronously rotates with the slider 31. There is a certain gap between the idling wheel 36 and the cutting wheel 35 in a non-operating state, so as to make the idling wheel 36 close to or away from the cutting wheel 35 with the movement of the slider 31.

When the motor 21 is started forward, the torque of the motor 21 is transmitted to the brake mechanism through the transmission mechanism, so that the driving gear 231 rotates, and the driving shaft 24 rotates with the driving gear 231 and drives the cutting wheel 35 to rotate. Meanwhile, the driving gear 231 drives the first brake gear 232 to rotate, and the second brake gear 233 rotates synchronously with the first brake gear 232 so as to drive the third brake gear 234 to rotate. The cam 235 rotates with the third brake gear 234, the cams 235 drives the driven member 32 to move, the driven member 32 pushes the slider 31 to move, and the gasket 33 drives the idling wheel 36 to move, so that the idling wheel 36 moves close to the cutting wheel 35, and the rim of the lid is clamped by cooperating the idling wheel 36 with the cutting wheel 35. Then, the third brake gear 234 does not rotate (since the third brake gear 234 is fan-shaped, the third brake gear 234 will not be driven to rotate due to the meshing relationship with the second brake gear 233 after it rotates by a certain angle), and the cutting wheel 35 is continuously driven to rotate by the driving shaft 24, so that the idling wheel 36 and the cutting wheel move along the rim of the lid and do a circular motion about the center of the can so as to press and cut the rim of the lid and to separate the lid from the body of the can.

After the circular motion of the idling wheel 36 and the cutting wheel 35 is finished, the lid is separated from the can body, the motor 21 rotates in the reverse direction, and all the components retract in the direction opposite to the feeding.

In conclusion, in the electric opener of the present invention, when the first brake gear 232 and the second brake gear 233 are connected through the elastic coupling, firstly, compared with the metal spring, the elastic coupling is easier to mount and will not be bounced; secondly, compared with the metal spring, no impact will be caused during the reversion of the elastic coupling, it is avoided that the metal spring is easier to break under repeated impact, thereby the elastic coupling having longer service life; and thirdly, compared with one-side contact and guidance, the elastic coupling is stressed more uniformly and more stable in use due to uniform evenly circumferential contact.

1. An elastic coupling assembly comprising:
a first brake gear (232);
a second brake gear (233) arranged coaxially with the first brake gear (232);
a coupling (236) for connecting the first brake gear (232) and the second brake gear (233);
a plurality of elastic bodies (237);
a plurality of first protrusions (2321) arranged on the first brake gear (232);
at least two second protrusions (2361) arranged on the coupling (236);
wherein,
the plurality of first protrusions (2321) is arranged on a surface of the first brake gear (232) which faces the second brake gear (233); the at least two second protrusions (2361) are arranged at intervals on the surface of the coupling (236) which faces the first brake gear (232);
each second protrusion (2361) has a notch (2362) for receiving one elastic body (237), each elastic body (237) is partially located inside the notch (2362) and partially extends out from the notch (2362);
each first protrusion (2321) is clamped between two adjacent second protrusions (2361); when the first brake gear (232) rotates in one direction, each first protrusion (2321) comes into contact with the corresponding elastic body (237), when the first brake gear (232) rotates in the other direction, each first protrusion (2321) comes into contact with the second protrusion (2361) opposite to the corresponding elastic body (237).

2. The elastic coupling assembly of claim 1, wherein the plurality of first protrusions (2321) is distributed radially, and a circular ring (2322) is arranged in a center of the plurality of first protrusions (2321);
the plurality of second protrusions (2361) is distributed radially, and the coupling (236) matches the circular ring (2322) of the first brake gear (232) at a center of the plurality of second protrusions (2361).

3. The elastic coupling assembly of claim 1, wherein a plurality of third protrusions (2332) distributed radially is arranged on the surface of the second brake gear (233) facing the first brake gear (232), so as to be engaged with the coupling (236).

4. An electric can opener having the elastic coupling assembly of claim 1, comprising a driving mechanism which comprises a motor (21) having an output, a transmission mechanism and a brake mechanism;
wherein,
the electric can opener has a first load and a second load;
the brake mechanism comprises an input end capable of braking the first load of the electric can opener, and an output end which is driven to move by the second brake gear (233) and is capable of braking the second load of the electric can opener;
the output of the motor (21) is transmitted to the input end of the brake mechanism by the transmission mechanism transmits, the first brake gear (232) is connected to and driven to rotate by the input end;
the motor (21) is capable of rotating positive direction or negative direction.

5. The electric can opener of claim 4, wherein the input end is a driving gear (231) which meshes with the first brake gear (232), the output end comprises a third brake gear (234) and a cam (235) which rotate together, and the third brake gear (234) meshes with the second brake gear (233).

6. The electric can opener of claim 5, wherein the driving mechanism further comprises a driving shaft (24) which passes through the driving gear (231) and the third brake gear (234), and the driving shaft (24) rotates together with the driving gear (231), and is capable of rotating relative to the third brake gear (234).

7. The electric can opener of claim 4, wherein the transmission mechanism is a gear set, a primary gear of the transmission mechanism is connected to the output shaft (211) of the motor (21), and a final gear of the transmission mechanism meshes with the driving gear (231).

8. The electric can opener of claim 4, wherein the electric can opener comprises a housing (1) and a cutting assembly (3), the motor (21) and the transmission mechanism of the driving mechanism are disposed inside the housing (1), the output end of the brake mechanism is disposed outside the housing (1), and, the input end and the output are respectively connected to the cutting assembly (3).

9. The electric can opener of claim 6, wherein the electric can opener comprises a housing (1) and a cutting assembly (3), and the cutting assembly (3) comprises a slider (31), a driven member (32), a cutting wheel (35) as the first load, and an idling wheel (36) as the second load, the driven member (32) is disposed between the slider (31) and the third brake gear (234), the cam (235) is disposed in the driven member (32) and can push the driven member (32) to move, so that the driven member (32) is capable of pushing the slider (31) to move; the cutting wheel (35) and the idling wheel (36) are disposed on one side of the slider (31) away from the driven member (32), the driving shaft (24) passes through the driven member (32) and the slider (31) to be fixedly connected to the cutting wheel (35), and, the idling wheel (36) can be fixedly connected to the slider (31), so as to make the idling wheel (36) close to or away from the cutting wheel (35) with the movement of the slider (31).

10. The electric can opener of claim 9, wherein the housing (1) comprises a mounting seat (11) having a recess extending upward from a bottom surface of the housing (1) facing the can;
the input end, the first brake gear (232) and the second brake gear (233) are located inside the housing (1), and the third brake gear (234) and the cam (235) are located in the mounting seat (11), the mounting seat (11) has a gap (111) at the sidewall of the housing (1), and partial of second brake gear (233) is engaged with the third brake gear (234) after passing through the gap (111), and, the idling wheel (36) is at least partially located in the mounting seat (11).
